(19) United States
(12) Patent Application Publication
(10) Pub. No.: US 2021/0209676 A1
(43) Pub. Date: Jul. 8, 2021

(54) METHOD AND SYSTEM OF AN AUGMENTED/VIRTUAL REALITY PLATFORM

(71) Applicant: VIKRUM SINGH DEOL, PLEASANTON, CA (US)

(72) Inventor: VIKRUM SINGH DEOL, PLEASANTON, CA (US)

(21) Appl. No.: 17/106,064

(22) Filed: Nov. 27, 2020

Related U.S. Application Data
(63) Continuation-in-part of application No. 16/885,253, filed on May 27, 2020, now abandoned.
(60) Provisional application No. 62/853,108, filed on May 27, 2019.

(51) Int. Cl. G06Q 30/06; G06T 19/00; G06Q 30/02; H04W 4/021; G06N 20/00

(52) U.S. Cl. CPC G06Q 30/0643; G06T 19/006; G06N 20/00; H04W 4/021; G06Q 30/0267

(57) ABSTRACT

In one aspect, a computerized method for implementing an augmented reality (AR)/virtual reality (VR) session includes the step of providing an AR/VR engine communicatively coupled with a user AR/VR device. The AR/VR engine obtains a set of digital content and communicates the set of digital content to the user-side AR/VR device. The method includes the step of determining that a user initiates a broadcast for a service or product. The method includes the step of, with the AR/VR engine, notifying the user via the user AR/VR device of a relevant service or product provider of broadcast by sending a push notification to the relevant service or product provider. The method includes the step of enabling an interaction between the user and the relevant service or product provider.

### CLAIM OF PRIORITY AND INCORPORATION BY REFERENCE

This application claims priority from U.S. patent application Ser. No. 16/885,253, filed 29 May 2020 and titled METHOD AND SYSTEM OF AN AUGMENTED/VIRTUAL REALITY ENGINE. This application is hereby incorporated by reference in its entirety for all purposes. U.S. patent application Ser. No. 16/885,253, claims priority from U.S. Provisional Patent Application No. 62/853,108, filed 27 May 2019 and titled A SYSTEM AND METHOD FOR PERMEATING COLOR INTO COMPONENTS. This application is hereby incorporated by reference in its entirety for all purposes.

### FIELD OF THE INVENTION

The applicants related generally to augmented and virtual reality systems and more specifically, to an augmented/virtual reality engine and AR/VR chatbot platform.

### DESCRIPTION OF THE RELATED ART

Augmented Reality (AR) and virtual reality (VR) have increased in popularity. For example, several popular VR gaming headsets are now available. Smart phones are ubiquitous and provide users access to AR environments. Accordingly, many enterprises and business have increased use of AR/VR technology. For example, AR/VR technology is now used in marketing campaigns with AR/VR billboards, commercials, and the like.

However, the current use of AR/VR by enterprises is disorganized. There is no higher meaning or purpose behind current AR/VR uses with each enterprise selecting its own strategy for showing data and advertisements. Accordingly, there is a need for a structured and unified approach for delivering AR/VR in a way standardized manner that enables enterprises and users to interact in a consistent, prescriptive, and predictive manner.

### SUMMARY OF THE INVENTION

In one aspect, a computerized method for implementing an augmented reality (AR)/virtual reality (VR) session includes the step of providing an AR/VR engine communicatively coupled with a user AR/VR device. The AR/VR engine obtains a set of digital content and communicates the set of digital content to the user-side AR/VR device. The method includes the step of determining that a user initiates a broadcast for a service, product, or broadcast for their social well interest. If the user chooses to allow their identity to be discoverable, their virtual avatar is available in real-time in VR and AR environments (e.g. via a Google Streetview implementation, AR implementation as provided in, inter alia, FIG. 17 infra). The method includes the step of, with the AR/VR engine, notifying the user via the user AR/VR device of a relevant service or product provider of broadcast by sending a push notification to the relevant service or product provider. The method includes the step of enabling an interaction between the user and the relevant service or product provider.

In another aspect, a computerized method for implementing an AR/VR billboard includes the step of determining the AR/VR billboard content. The method includes the step of setting a geo-fence of the AR/VR billboard. The method includes the step of detecting that a user with an AR/VR device has entered the geo-fence. The AR/VR billboard comprises a set of digital AR/VR elements that are viewable by the user AR/VR device while the user is within the geo-fence. The method includes the step of determining that the user is in an on-grid mode. The method includes the step of determining a region of gaze of the user. The method includes the step of determining the persons best interest in prioritized fashion to render more relevant AR content to the user inherent preference. The method includes utilizing meta data from the AR experience such as but not limited to user interaction, dwell time, navigation, direction, gyroscope, velocity, and or metrics or related analytics to enhance user experience in AR. The method includes the step of securing an AR portal for augmented reality viewing privacy. The method includes the step of communicating the AR/VR billboard content to the AR/VR device of the user. The method includes the step of displaying the AR/VR billboard content in the AR/VR device of the user. The method includes the step of detecting a user interaction with the AR/VR billboard content. he method includes the step of communicating with users that are on the grid in augmented or virtual reality format. The method includes the step of displaying personal or business banners overhead that are displaying the user's broadcast which can be coupled with tags, videos, GPS, menu items, logos, sponsors, and [are adaptable to user preference i.e. display lipstick to one user of all menu items, display lawn tools to the other user from same menu list.] The method includes the step of interacting in real-time with another users broadcast in AR/VR view. The method includes the step of buying in real-time from another user in AR/VR mode or on-grid. The method includes the step of, based on the user interaction with the AR/VR billboard content, implementing a specified action.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for implementing augmented/virtual reality engine, according to some embodiments.

FIG. 2 illustrates a side view of illustrates a front view of an augmented-reality glasses in an example eyeglasses embodiment.

FIG. 3 illustrates one example of obtaining user data from a user viewing, a digital document (such as a text message) and/or an object via a computer display and an outward facing camera.

FIG. 4 depicts an exemplary computing system that can be configured to perform any one of the processes provided herein.

FIG. 5 illustrates an example process for toggling a user mode in an AR/VR platform, according to some embodiments.

FIG. 6 illustrates an example process for implementing an AR/VR platform session, according to some embodiments.

FIG. 7 illustrates an example process for a goods or services provider to engage with customer AR/VR broadcast, according to some embodiments.

FIG. 8 illustrates an example process of an augmented/virtual reality platform, according to some embodiments.

FIG. 9 illustrates an example process for implementing an AR/VR billboard, according to some embodiments.

FIG. 10 illustrates an example process for implementing a broadcasts in an AR/VR platform, according to some embodiments.

FIGS. 11-13 illustrates an example set of screenshots showing a user create a broadcast and a broadcast state.

FIG. 14 illustrates a screenshot of a user interface of a series of broadcast interactions between a user and a set of businesses, according to some embodiments.

FIG. 15 illustrates a map-based broadcast interface, according to some embodiments.

FIG. 16 illustrates an example screenshot of a list of entities that match a user's broadcast specifications, according to some embodiments.

FIG. 17 illustrate an example screenshot of a user interface for an AR view of a broadcast interface, according to some embodiments.

FIGS. 18-20 illustrate an additional set of example screenshots regarding user broadcasts, according to some embodiments.

FIGS. 21-22 illustrate an example discovery option/service, according to some embodiments.

FIGS. 23-27 illustrate a map-based interface for discovering and interacting with other users via their respective broadcasts, according to some embodiments.

The Figures described above are a representative set, and are not an exhaustive with respect to embodying the invention.

### DESCRIPTION

Disclosed are a system, method, and article of manufacture of an augmented/virtual reality engine and chatbot platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, relationship structures, logic-based algorithms, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Artificial intelligence (AI) is intelligence demonstrated by machines.

Augmented reality (AR) is an interactive experience of a real-world environment where the objects that reside in the real-world are augmented by computer-generated perceptual information, sometimes across multiple sensory modalities, including visual, auditory, haptic, somatosensory, and olfactory.

Deep learning is a family of machine learning methods based on learning data representations. Learning can be supervised, semi-supervised or unsupervised.

Chatbot is a computer program and/or an artificial intelligence which conducts a conversation via auditory or textual methods. Such programs are often designed to convincingly simulate how a human would behave as a conversational partner, thereby passing the Turing test. Chatbots are typically used in dialog systems for various practical purposes including customer service or information acquisition. A chatbot can use sophisticated natural language processing systems and then pull a reply with the most matching keywords and/or the most similar wording pattern, from a database.

Geofence is a virtual perimeter for a real-world geographic area. A geo-fence could be dynamically generated. This can be a radius around a point location. A geo-fence can be a predefined set of boundaries (e.g. a region around an AR/VR billboard, a neighborhood, a dynamic zone around a user, vehicle, other movable AR/VR display, etc.). In some embodiments, a geo-fence is personalized for each user allowing dynamic adjustments or guided by data engineering.

Geotagging is the process of adding geographical identification metadata to various media such as a geotagged photograph or video, websites, SMS messages, QR Codes (and/or other matrix codes) or RSS feeds. Geotagging include geospatial metadata. The geospatial data in geo-tags can include of latitude and longitude coordinates, etc. The geospatial data in geo-tags can also include altitude, inter alia: bearing, distance, accuracy data, MAC address, triangulation, IP address correlation, additional data for cross-verification of GPS, and place names, a time stamp, etc.

Gesture recognition interprets human gestures viewable by a computing system via a set of computer-processable mathematical algorithms. Gestures can originate from any bodily motion or state (e.g. originate from the face or hand).

Head-mounted display (HMD) is a display device, worn on the head or as part of a helmet, that has a small display optic in front of one (monocular HMD) or each eye (binocular HMD).

Head-up display or heads-up display (HUD) is any transparent display that presents data without requiring users to look away from their usual viewpoints. HUDs can be used for example, in vehicles and glass projections from a display module/apparatus.

Machine learning is a type of artificial intelligence (Al) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Mixed reality (MR) is the merging of real and virtual worlds to produce new environments and visualizations, where physical and digital objects co-exist and interact in real time. Mixed reality can be a hybrid of reality and virtual reality, encompassing both augmented reality and augmented reality via various immersive technology (e.g. such as the AR/VR systems provided herein).

Natural language processing (NLP) is a subfield Al that with the interactions between computers and human (natural) languages and concerns programing computers to process and analyze large amounts of natural language data. NLP can utilize speech recognition, natural language understanding, natural language generation, etc.

Omnidirectional camera (e.g. 360-degree camera, etc.) is a camera having a field of view that covers approximately the entire sphere or at least a full circle in the horizontal plane.

Optical head-mounted display (OHMD) is a wearable device that has the capability of reflecting projected images as well as allowing the user to see through it.

Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set.

Volumetric video is a technique that captures a three-dimensional space, such as a location or performance.

Virtual reality (VR) is a simulated experience that can be similar to or completely different from the real world. Applications of virtual reality can include entertainment (i.e. video games) and educational purposes (i.e. medical or military training). It is noted that other types of VR style technology can be used in lieu or and/or in combination with VR herein. These can include, inter alia: augmented reality (AR) and mixed reality.

VR headset is a head-mounted device that provides virtual reality for the wearer. VR headsets are widely used with video games but they are also used in other applications, including simulators and trainers. They can be a stereoscopic head-mounted display (e.g. providing separate images for each eye), stereo sound, and head motion tracking sensors (e.g. may include gyroscopes, accelerometers, magnetometers, structured light systems etc.). Example VR headsets also have eye tracking sensors and gaming controllers.

### Exemplary Systems

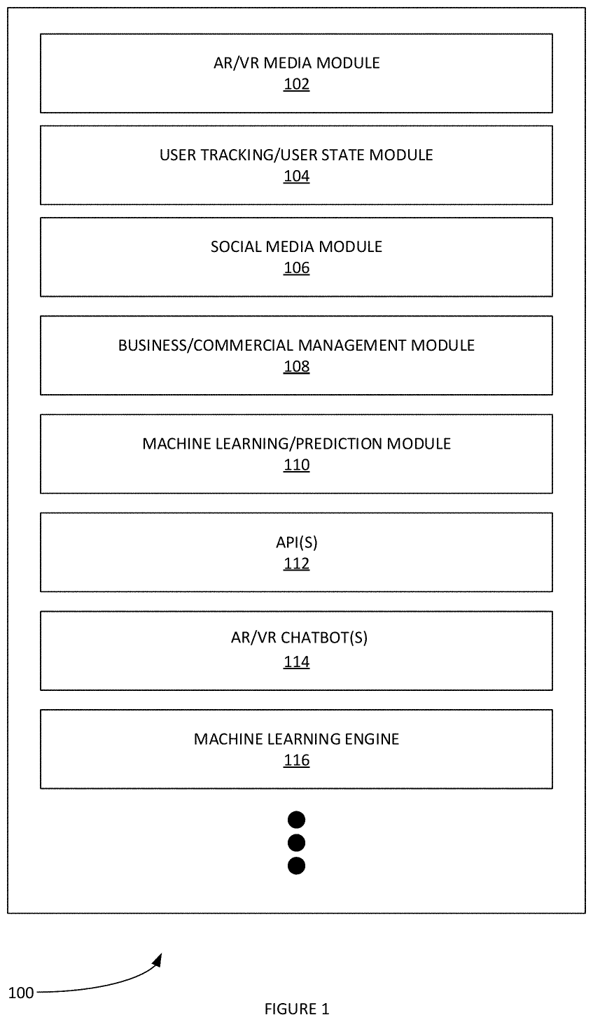

FIG. 1 illustrates an example process 100 for implementing augmented/virtual reality engine 100, according to some embodiments. Augmented/virtual reality engine 100 can be used to implement an augmented/virtual reality platform. Augmented/virtual reality engine 100 can manage a global augmented/virtual reality experience that associates augmented/virtual reality elements with physical objects and/or locations in specified geographical real-world locations. Augmented/virtual reality engine 100 can gather data from various data sources (e.g. user applications (e.g. YELP®, GRUB HUB®, UBER®, etc.), business/enterprise databases, governmental organization databases, etc.). Augmented/virtual reality engine 100 can consolidate this data and create augmented/virtual reality elements for display in an augmented/virtual reality view overlaid on a physical object/location.

Augmented/virtual reality engine 100 can enable exploration of the combined AR/VR world. For example, based on explicit and/or implicit preferences the Augmented/virtual reality engine 100 can align the AR/VR world with the user's agenda. For example, on Tuesday morning, the augmented/virtual reality engine 100 can guide (e.g. using AR/VR elements displayed in the user's field of view) the user to STARBUCKS® and then, from STARBUCKS® to a relevant BART station. From the BART station, the augmented/virtual reality engine 100 can use AR/VR elements to guide the user to the user's workplace. On Saturday morning, the augmented/virtual reality engine 100 can guide the to a set of stairs for running. The Augmented/virtual reality engine 100 can display the user's exercise statistics (e.g. number of stairs run, heart rates, past records, etc.) in an AR/VR element. Other users can view this element with the user's permission. The augmented/virtual reality engine 100 can information the user about great brunch spots nearby. The augmented/virtual reality engine 100 can guide the user towards the user's friends (e.g. social networking contacts).

In one example, the augmented/virtual reality engine 100 can store information as to a user's favorite type of coffee. The augmented/virtual reality engine 100 can determine (e.g. via an IoT) that the user didn't have coffee at home that morning. According, the augmented/virtual reality engine 100 can place various coffee opportunities in a list of suggestions. augmented/virtual reality engine 100 can also data mine a user's texts, emails, online calendars, etc. generate a list of suggestions. For example, the augmented/virtual reality engine 100 can determine that the user has a birthday party to attend soon so it can prompt the user to stop by a cake shop and make an order. The augmented/virtual reality engine 100 can integrate with a self-service parcel delivery service offered by online retailer (e.g. Amazon Locker, etc.). Users can select any locker location as their delivery address, and retrieve their orders at that location by entering a unique pick-up code on the locker touch screen. It is noted that, based on user's agenda and context of living in a current time/place and data sources (e.g. text email, etc.) can be pre-approved by the user as sources for suggestions.

The augmented/virtual reality engine 100 can broadcast information that is relevant to the user. These broadcasts can include (or not include), visual status icons, avatars, sponsored or purchased labels, and audio elements. These can be status icons. Status icons can be dynamically updated based on a user-related context. For example, one day the icon can be a sport's team logo, the next day a video from the user's recent vacation, a following week it can include a political meme, etc. All the information displayed/broadcast to the user can be relevance based. A user can adjust relevance and/or to other settings/filters (e.g. see all AR/VR displays/broadcasts, see only above a specified relevance threshold, etc.). The augmented/virtual reality engine 100 can determine relevance based on learning various user preferences and/or patterns. Relevance can also be determined by various other factors such as, inter alia: good or service price, deals related to various preferred goods and/or services, availability of goods and/or services, etc.

In this way, augmented/virtual reality engine 100 can provide relevance-based information to an end user/requestor. For example, the augmented/virtual reality engine 100 can enable local business(es) that are relevant to engage the user via AR/VR displays sent to the user.

Based on request, routine, agenda, activity, all various components of a user's daily activities can be determined and relevant AR/VR elements can be displayed to the user. Augmented/virtual reality engine 100 can continuously gather information and utilized this information to delivers relevant information to the user using the application in a seamless manner. As provided infra, augmented/virtual reality engine 100 can use various machine-learning and/or optimization algorithms to determine a set of most relevant AR/VR elements to provide to the user.

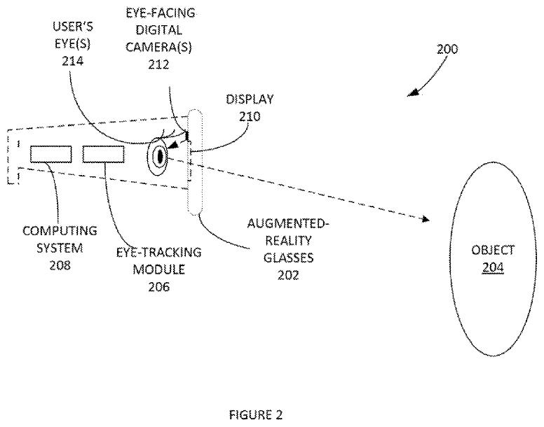

In one example, an end user/requestor can wear/use an augmented/virtual reality system (e.g. an HMD, head-up display, augmented-reality glasses, a mobile device touchscreen, etc.). The augmented/virtual reality system can obtain user location, view orientation, eye-tracking data, head position data, vehicle or device position, travel/movement vectors, other user context data and communicate said data to the augmented/virtual reality engine 100. Augmented/virtual reality systems can receive augmented/virtual reality data from augmented/virtual reality engine 100. Augmented/virtual reality systems can display augmented/virtual reality data as augmented/virtual reality elements. Augmented/virtual reality systems run various client-side AR/VR applications. Examples of augmented/virtual reality systems are provided infra (e.g. see FIGS. 2-4).

The augmented/virtual reality system can be communicatively coupled with the augmented/virtual reality engine 100 via various computer network(s) (e.g. the Internet, LANs, WANs, local Wi-Fi, cellular data networks, enterprise network, etc.).

Augmented/virtual reality engine 100 can include various modules for managing the augmented/virtual reality platform. For example, augmented/virtual reality engine 100 can include AR/VR module 102. AR/VR module 102 can generate AR/VR display elements. AR/VR display elements can include, inter alia: rich media elements, text, moving images, animations, videos, audio files, video games, live-video stream, etc. Rich media elements can be interactive with respect to the user's actions by presenting content. AR/VR display elements can include metadata relevant to the display of the AR/VR display elements. Example metadata can include, inter alia: display location, dwell time, display duration, types of input acceptable by the AR/VR display element, permissions for access to AR/VR display element, holograms, other advanced graphics, etc.

AR/VR module 102 can provide a series of AR/VR elements to be displayed in a specified order. AR/VR module 102 can provide modified AR/VR elements based on user/viewer attributes. For example, AR/VR elements can be modified based on viewer age, location, other demographic attributes, user social network connections, current user context (e.g. on way to work, at a sports game, on vacation, etc.). AR/VR module 102 can track which AR/VR elements are displayed to the user along with relevant display information (e.g. user responses, time of display, location of display, etc.). AR/VR module 102 can store this data in a data store.

AR/VR module 102 can obtain AR/VR elements, or portions thereof, from third-party servers. This can include proprietary design GUI elements from specific products to be advertised in the AR/VR elements. AR/VR module 102 can access third-party servers via APIs 112.

Augmented/virtual reality engine 100 can include user tracking/user state module 104. User tracking/user state module 104 can track various relevant attributes of the user. This information can be used to ensure relevancy of AR/VR elements served by the AR/VR module 102. For example, user tracking/user state module 104 can obtain various real-world attributes of the user. These can include, inter alia: user location, user travel history, user routine, user head/body orientation, device position, user field of view, etc. User tracking/user state module 104 can track various other user state attributes, including, inter alia: user mood, user vocation, user social networking contacts, user family location, etc. User tracking/user state module 104 can track relevant non-user information, including, inter alia: weather information, nearby events, nearby commercial/entertainment/educational/recreational opportunities, nearby other users, traffic conditions, routing information, etc. Accordingly, user tracking/user state module 104 can be queried to provide user location, user state and other relevant information. This information can be used to generate relevant AR/VR displays for the user at any given time. Additionally, uses of AR/VR displays can include, inter alia: online gaming, virtually visiting a site location with enterprise locations broadcasted, distributed virtual environments, whiteboards for virtual meetings, interactive conferences, virtual rooms, augmented presence within an area, location, room, etc.

Augmented/virtual reality engine 100 can include social media module 106. Social media module 106 can track user social media resources. These can include user online social networking contacts. In this way, social media module 106 can be queried to provide a current location of the user's relevant/local social media contacts. The relevant/local social media contact information can be integrated into AR/VR displays.

Augmented/virtual reality engine 100 can include business/commercial management module 108. Business/commercial management module 108 can manage e-commerce functionalities to users. These e-commerce functionalities can be integrated into AR/VR displays. User can interact with some AR/VR displays to purchase various goods and/or services and/or receive payment for goods and/or services rendered by the user. For example, AR/VR displays can be used to pay for ride sharing services, physical products, access to various AR/VR e-stores, AR/VR sellers, AR/VR marketplaces, AR/VR video games, real-world entertainment/sports venues, AR/VR world entertainment/sports venues, etc.

Augmented/virtual reality engine 100 can include machine learning/prediction module 110. Machine learning/prediction module 110 can obtain data from the other modules of augmented/virtual reality engine 100. Machine learning/prediction module 110 can implement machine learning algorithms on the data and obtain patterns and inference from said data. Machine learning/prediction module 110 can enable the various modules of augmented/virtual reality engine 100 to perform specific tasks without using explicit instructions. Machine learning/prediction module 110 can make predictions regarding user behavior with the AR/VR world and/or real world. These predictions can be used to enhance the user's AR/VR experience. For example, the machine learning/prediction module 110 can use a user's current location, current travel direction and historical route data to predict a user's future location. Augmented/virtual reality engine 100 can then pre-generate relevant AR/VR elements for display in the predicted user's future location.

Augmented/virtual reality engine 100 can include other systems/functionalities not shown. These can include, inter alia: web servers, database managers, email servers, instant message servers, search engines, recommendation engines, online social network engines, geolocation systems, etc.

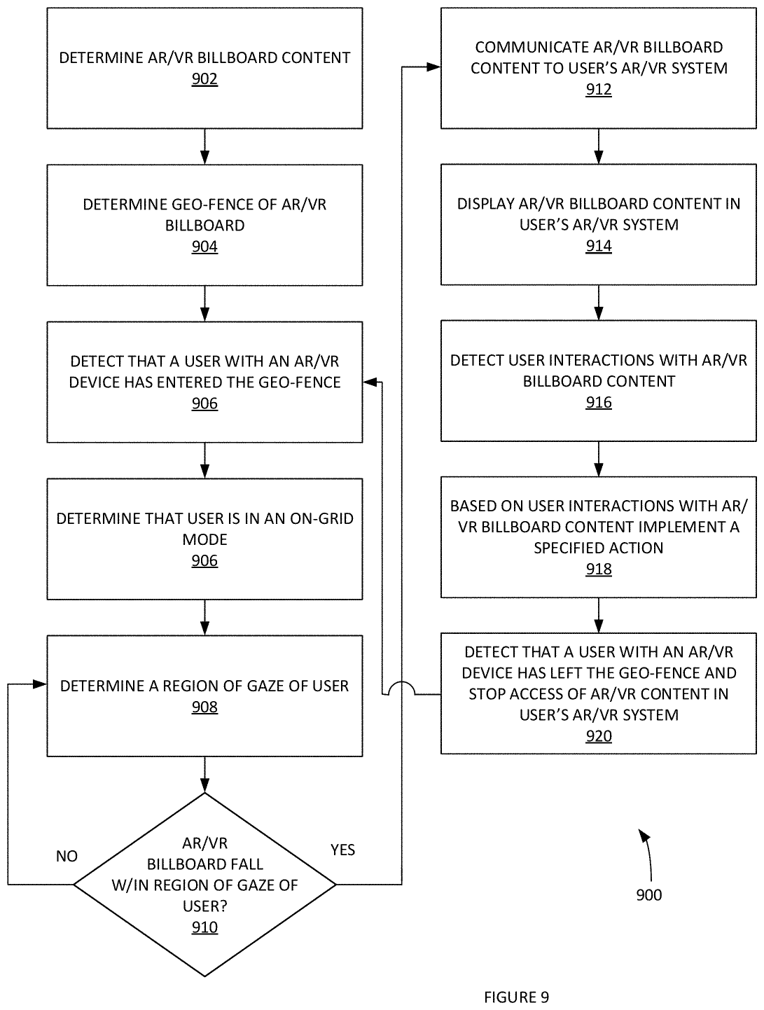

Augmented/virtual reality engine 100 can implement virtual billboards (e.g. see FIG. 9 infra). It is noted that the users can set virtual-billboard preferences. Users can view virtual billboards as the Drive/Walk/Run via HUD and/or HMD, digital camera, screen display, or any VR/AR apparatus via HUD and/or HMD. Augmented/virtual reality engine 100 can manage the rental of virtual billboard space. Eye tracking, gesture tracking, view tracking and/or other metric can be used to track views of users of each virtual billboard. The virtual billboard can present users with AR/VR advertisements based on the user preferences. Augmented/virtual reality engine 100 can use group logic to determine a best advertisement to display for each virtual billboard location. AR/VR based advertisements can be grouped for sequential display on a virtual billboard. Augmented/virtual reality engine 100 can sends particularized information to personal dashboards to further allow engagement and/or help aid in everyday functions.

Augmented/virtual reality engine 100 can manage interactive VR billboard so that a user can have a chat session with an AR/VR advertisement or with a business about an AR/VR advertisement. Augmented/virtual reality engine 100 can manage tracking analytics of users who pass by and/or otherwise interact with an AR/VR advertisements.

Augmented/virtual reality engine 100 can provide personal broadcasts of AR/VR content. A user can choose to view all relevant sets of AR/VR broadcasts. Augmented/virtual reality engine 100 can use a logic-based approach for determining user preferences and then align AR/VR broadcast with the user's life agenda. Augmented/virtual reality engine 100 can enable AR/VR elements that provide chat functionalities. Augmented/virtual reality engine 100 can allows interests groups to further engage specified AR/VR displays. In this way, Augmented/virtual reality engine 100 can enable a social dynamic. Augmented/virtual reality engine 100 can enable users to purchase avatars or logos for further broadcasts and/or augmented/virtual displays in real-time and in virtual and/or augmented presence.

Augmented/virtual reality engine 100 can enable users to generate AR/VR elements and/or broadcasts. The user can determine the protocols of the display. For example, the user can manage permissions of who can view the AR/VR elements and/or broadcasts and/or the interactions of other users therewith.

Augmented/virtual reality engine 100 can enable users to engage with any business with a direct communication capability. Users can search for a good or service. Users can select goods or services based on preferences. Users can automatically be provided routes based on routine/agenda. Augmented/virtual reality engine 100 can automatically route users to the manufacturer and/or shop to purchase. Augmented/virtual reality engine 100 can enable users to chat with either manufacturer or shop that generated an AR/VR broadcast the user is interacting with. The augmented/virtual reality engine 100 can provide a direct purchasing capability via the platform to enable quick pickups at the stores.

AR/VR chat bot(s)114 is a computer program and/or an artificial intelligence which conducts a conversation via AR/VR and/or other auditory, textual methods. AR/VR Chat bot(s)114 can generate and manage an AR/VR environment as part of a chatbot interaction with a user using an AR/VR device. AR/V chatbots 114 can include chatbot dialog systems and AR/VR generation system for various practical purposes including customer service or information acquisition. AR/VR chatbot 114 can use sophisticated natural language processing systems and then pull a reply with the most matching keywords and/or the most similar wording pattern, from a database.

Machine learning engine 116 can utilize machine learning algorithms to recommend and/or optimize various peer-to-peer delivery services. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

FIG. 2 illustrates a side view of illustrates a front view of an augmented-reality glasses 202 in an example eyeglasses embodiment. Although this example embodiment is provided in an eyeglasses format, it will be understood that wearable systems may take other forms, such as hats, goggles, masks, headbands, and helmets. Augmented-reality glasses 202 may include an OH MD. Extending side arms may be affixed to the lens frame. Extending side arms may be attached to a center frame support and lens frame. Each of the frame elements and the extending side-arm may be formed of a solid structure of plastic or metal, or may be formed of a hollow structure of similar material so as to allow wiring and component interconnects to be internally routed through the augmented-reality glasses 202. A lens display may include lens elements that may be at least partially transparent so as to allow the wearer to look through lens elements. In particular, a user's eye 204 of the wearer may look through a lens that may include display 206. One or both lenses may include a display. Display 206 may be included in the augmented-reality glasses 202 optical systems. In one example, the optical systems may be positioned in front of the lenses, respectively. Augmented-reality glasses 202 may include various elements such as a computing system 208, user input device(s) such as a touchpad, a microphone, and a button. Augmented-reality glasses 202 may include and/or be communicatively coupled with other biosensors (e.g. with NFC, Bluetooth®, etc.). The computing system 208 may manage the augmented reality operations, as well as digital image and video acquisition operations. Computing system 208 may include a client for interacting with a remote server (e.g. augmented-reality (AR) messaging service, other text messaging service, image/video editing service, etc.) in order to send user data (e.g. eye-tracking data, other biosensor data) and/or camera data and/or to receive information about aggregated eye tracking/other user data (e.g., AR messages, and other data). For example, computing system 208 may use data from among other sources, various sensors, and cameras (e.g. outward facing camera that obtain digital images of object 204) to determine a displayed image that may be displayed to the wearer. Computing system 208 may communicate with a network such as a cellular network, local area network and/or the Internet. Computing system 208 may support an operating system such as the Android™ and/or Linux operating system. The optical systems may be attached to the augmented reality glasses 202 using support mounts. Furthermore, the optical systems may be integrated partially or completely into the lens elements. The wearer of augmented reality glasses 202 may simultaneously observe from display 206 a real-world image with an overlaid displayed image. Augmented reality glasses 202 may also include eye-tracking system(s) that may be integrated into the display 206 of each lens. Eye-tracking system(s) may include eye-tracking module 210 to manage eye-tracking operations, as well as, other hardware devices such as one or more a user-facing cameras and/or infrared light source(s). In one example, an infrared light source or sources integrated into the eye-tracking system may illuminate the eye of the wearer, and a reflected infrared light may be collected with an infrared camera to track eye or eye-pupil movement. Other user input devices, user output devices, wireless communication devices, sensors, and cameras may be reasonably included and/or communicatively coupled with augmented-reality glasses 202. In some embodiments, augmented-reality glass 202 may include a virtual retinal display (VRD). Computing system 208 can include spatial sensing sensors such as a gyroscope and/or an accelerometer to track direction user is facing and what angle her head is at.

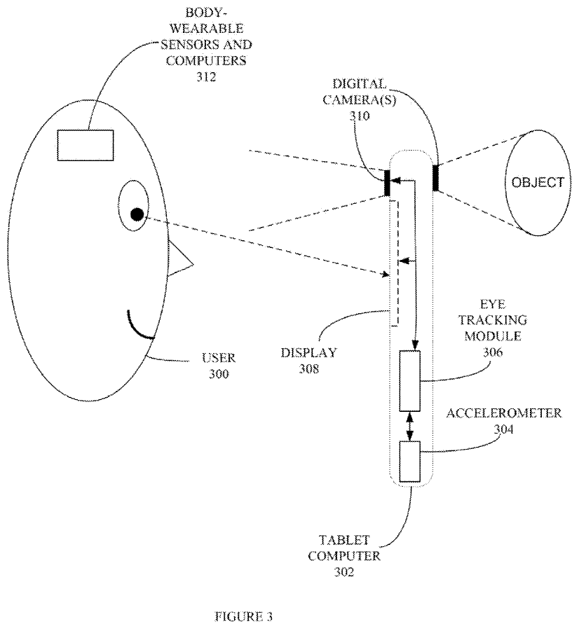

FIG. 3 illustrates one example of obtaining user data from a user viewing, a digital document (such as a text message) and/or an object via a computer display and an outward facing camera. In one embodiment, eye-tracking module 340 of user device 310 tracks the gaze 360 of user 300. Although illustrated here as a generic user device 310, the device may be a cellular telephone, personal digital assistant, tablet computer (such as an iPad®), laptop computer, in-car computer/operating system, desktop computer, or the like. Eye-tracking module 340 may utilize information from at least one digital camera 320 (outward and/or user-facing) and/or an accelerometer 350 (or similar device that provides positional information of user device 310) to track the user's gaze 360. Eye-tracking module 340 may map eye-tracking data to information presented on display 330. For example, coordinates of display information may be obtained from a graphical user interface (GUI). In some embodiments, eye-tracking module 340 may use an eye-tracking: method to acquire the eye movement pattern. In one embodiment, an example eye-tracking method may include an analytical gaze estimation algorithm that employs the estimation, of the visual direction directly from selected eye features such as irises, eye corners, eyelids, or the like to compute a gaze 360 direction. If the positions of any two points of the nodal point, the fovea, the eyeball center, or the pupil center can be estimated, the visual direction may be determined. In addition, light may be included on the front side of user device 310 to assist detection of any points hidden in the eyeball. Moreover, the eyeball center may be estimated from other viewable facial features indirectly. In one embodiment, the method may model an eyeball as a sphere and hold the distances from the eyeball center to the two eye corners to be a known constant. For example, the distance may be fixed to 13 mm. The eye corners may be located (e.g., by using a binocular stereo system) and used to determine the eyeball center. In one exemplary embodiment, the iris boundaries may be modeled as circles in the image using a Hough transformation. The center of the circular iris boundary may then be used as the pupil center. In other embodiments, a high-resolution camera and other image processing tools may be used to detect the pupil. It should be noted that, in some embodiments, eye-tracking module 340 may utilize one or more eye-tracking methods in combination. Other exemplary eye-tracking methods include: a 2D eye-tracking algorithm using a single camera and Purkinje image, a real-time eye-tracking algorithm with head movement compensation, a real-time implementation of a method to estimate gaze 360 direction using stereo vision, a free head motion remote eyes (REGT) technique, or the like. Additionally, any combination of any of these methods may be used. Body-wearable sensors 312 can be any sensor (e.g. biosensor, heart-rate monitor, galvanic skin response sensor, etc.) that can be worn by a user and communicatively coupled with tablet computer 302 and/or a remote server.

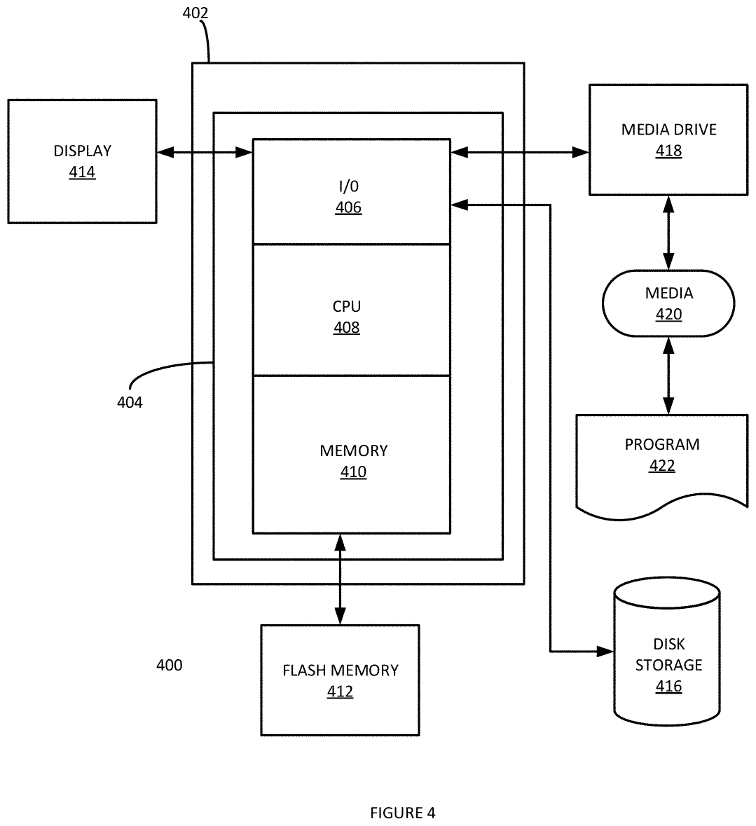

FIG. 4 depicts an exemplary computing system 400 that can be configured to perform any one of the processes provided herein. In this context, computing system1 700 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can be virtualized to reduce physical space. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### Example Processes

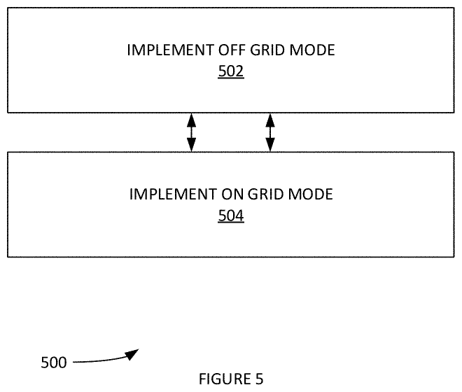

FIG. 5 illustrates an example process 500 for toggling a user mode in an AR/VR platform, according to some embodiments. In step 502, process 500 can implement an off-grid mode for the user. In the off-grid mode, user requests are not discoverable and hence not on the grid. In the off-grid mode, the user can search for various services (e.g. haircut, gardener, house painter, etc.). The user can interact with the manufacturer and service providers (e.g. via AR/VR displays in the user's field of view) while remaining private. The user can see results for a search query. However, this information isn't broadcasted. In some examples, the chat function or the user's personal display banner may not be available in the off-grid mode.

In step 504, process 500 can implement an on-grid mode. The on-grid mode can allow for user/group/entity searches. In on-grid mode, users can search for people, interest groups, businesses, social/business broadcasts, etc. The user can see other users engage in interactions with various AR/VR elements, etc. A user can see the frequency and/or degree of relations between users as well. Historical implicit associations (e.g. degree/angle of relationships in a social network, etc.) can also be provided. Conversation starters, prompts, notes about past interactions and/or common interests can be generated and displayed as well as suggestions on how to speak with the user. The user-side AR/VR application can automatically inform a user of social relationships with a social network and the frequency of the contact between the users. Process 500 can make introduction with other nearby relevant users. Users can be provided familiarity icons. These can be displayed as AR/VR elements.

In on-grid mode, process 500 can provide an exploration mode where the user can view other user(s) broadcasts. Users can initiate chats with various businesses. For example, users can see a realtor's broadcast and go to the home directly after typing in ‘open homes’ into a query.

In one example, a user can query a GPS location and create a query through a search engine. The user can then select a geographic image that represents the location. This image can be used to represent the user and be transmitted back to the user's screen. For example, if the user is on Golden Gate Bridge, process 500 can obtain an image of the Golden Gate Bridge and present it as the background of the screen where the user is standing without the having to take a picture of the user's location. However, the user can also use a mobile-device camera and emulate the user's position based on camera image.

### Additional Methods

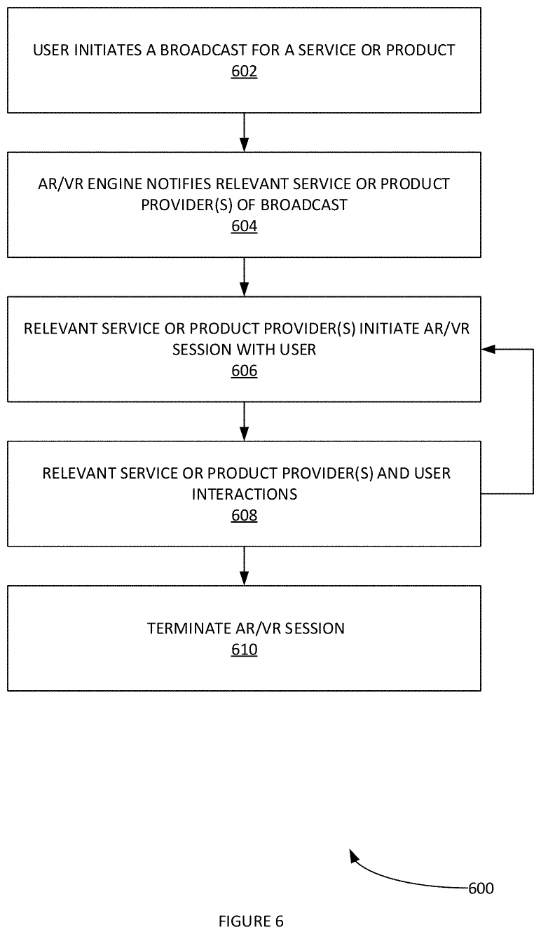

FIG. 6 illustrates an example process 600 for implementing an AR/VR platform session, according to some embodiments. In step 602, the user initiates a broadcast for a service or product. Example broadcasts are defined and/or provided supra and in the example user interfaces provided herein. Step 602 can be implemented using an AR/VR broadcasting application. The user can input text and/or audio input. This input can be parsed and a relevant service or product can be determined. In the case of ambiguity, process 600 can query the user to further resolve user intent and/or obtain additional details regarding the user's query. This query information and/or relevant metadata (e.g. user location, user demographics, user search history, user reviews on review web sites, user purchase history, user social networking history, etc.) can also be forwarded to the relevant service or product provider(s). This information can also be utilized by the machine-learning system (e.g. machine-learning engine 116 of FIG. 1) to optimize search results of the user and/or process 600 in general and/or make predictions regarding user intent.

In step 604, the AR/VR engine notifies relevant service or product provider(s) of broadcast. For example, process 600 can send push notifications to the relevant service or product provider(s). These can be reviewed and responded to by an employee and/or an AR/VR chat bot system. The relevant service or product provider(s).

In step 606, the relevant service or product provider(s) initiate AR/VR session with a user. For example, AR/VR chat bot system can interact with the user and process user requests. Based on user queries and/or other user metadata, the AR/VR chat bot system generates an AR/VR view of the relevant products and/or services. Process 600 can communicate and serve these to the user's AR/VR system.

In step 608, the relevant service or product provider(s) and user interactions are implemented. For example, during the AR/VR session, the user can make a reservation at a restaurant, purchase a product, schedule a service, etc. Process 600 can process the orders. Process 600 can make reservations in the relevant service or product provider(s) online cameras. Process 600 can make upgrades and/or provide other amenities to the user's schedule service based on user status and/or other rewards programs.

In step 610, process 600 terminates the AR/VR session when the user and relevant service or product provider(s) have completed their interaction(s). Process 600 can send reminders to the relevant parties. Process 600 can implement any e-commerce and/or payment processing as well.

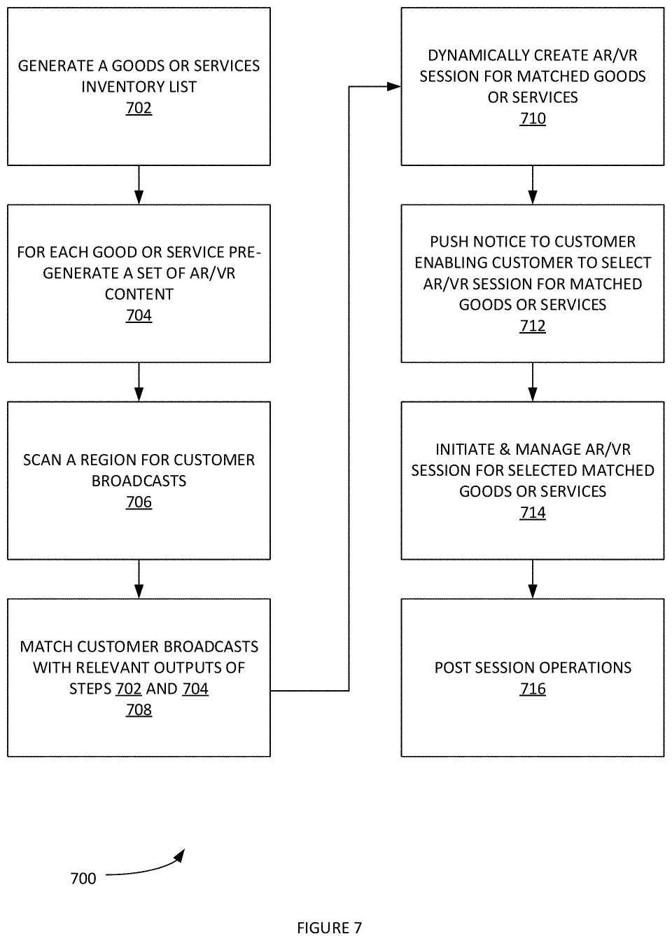

FIG. 7 illustrates an example process 700 for a goods or services provider to engage with customer AR/VR broadcast, according to some embodiments. In step 702, process 700 can generate a goods or services inventory list. Example goods or services can include, inter alia: clothing items, restaurant menus/tables, hotel rooms, vacation rentals, etc.

In step 704, for each good or service pre-generate a set of AR/VR content. For example, employees and/or robots can photograph and create videos of items related to the goods or services with an omnidirectional camera. Each good or service can have 360-degree videos (e.g. immersive videos, spherical videos, etc.) where a view in every direction is recorded at the same time, shot using an omnidirectional camera or a collection of cameras. During playback, the customer's AR/VR viewer has control of the viewing direction. The AR/VR content can be supplemented with animation, audio, hyperlinks, and/or other relevant content.

In other example embodiments, a 180-degree video can be generated with a stereoscopic camera that captures a 180-degree field of view. This can enable the depth to be maintained with the video having an equirectangular projection. In another example, a 6DOF video can be used with a stereoscopic 360-degree video camera. The 6DOF video can capture depth and allows for six degrees of freedom in navigation within a captured good, service and/or relevant environment. In another example, volumetric video techniques can be utilized.

In step 706, process 700 can scan a region for customer broadcasts. In some embodiments, the customer broadcasts can be fed to the goods or services providers via third-party area AR/VR networks. This can be when a customer is in an on-grid mode 514 (e.g. see supra).

In step 708, process 700 can match customer broadcasts with relevant outputs of steps 702 and 704. In some examples, ML engine 116 can be used to optimize recommendations and search results to be provided to step 708.

In step 710, process 700 can dynamically create AR/VR sessions for matched goods or services. This can be a life session. The AR/VR session can include input from an AR/VR chatbot. The AR/VR chat bot can implement various customer relationship management operations. The AR/VR chat bot can update the content of the AR/VR session with various marketing materials for the business implementing process 700. The AR/VR chat bot can include additional AR/VR elements based on customer attributes and/or context. For example, the AR/VR chat bot can take into consideration the customer's demographics, location, past search history, social networking data, etc. In this way, the AR/VR session can be dynamically customized for each user.

In step 712, process 700 can push notices to customers that enable customers to select AR/VR session for matched goods or services. In step 714, process 700 can initiate and manage the AR/VR session for selected matched goods or services. For example, the customer can indicate an interest in additional goods or services. The AR/VR chat bot can then obtain the good or service pre-generate a set of AR/VR content for the additional goods or services. The AR/VR chatbot can include this into the AR/VR session. The AR/VR chatbot can connect the customer with the customer service representative. For example, an avatar of the customer service representative can join the AR/VR session and the like. The AR/VR chatbot can follow up with the customer service representative that a sale item has been prepared for the customer to view or purchase.

In step 716, process 700 can implement post session operations. It is noted that the AR/VR chatbot can make reservations of the customer. The AR/VR chatbot can forwarded customer queries to a customer service representative. The AR/VR chatbot can initiate various e-commerce and/or other charging operations. The AR/VR chatbot can order items for the delivery to the customer. The AR/VR chatbot can update the customer's profile with the business or enterprise. The AR/VR chatbot can send reservation reminders to the customer and/or other follow up operations. The AR/VR chatbot can follow up with the customer service representative that a sale item has been prepared for the customer to view or purchase.

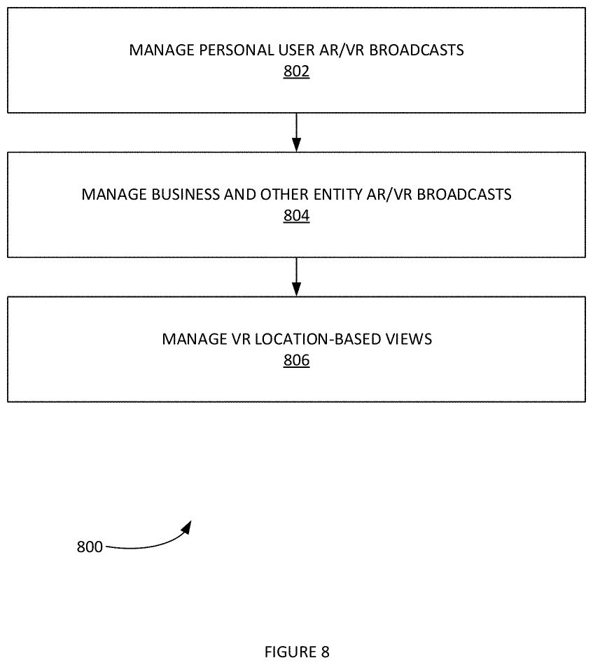

FIG. 8 illustrates an example process 800 of an augmented/virtual reality platform, according to some embodiments. In step 802, process 800 can manage personal user AR/VR broadcasts. User's can implement personal AR/VR broadcasts. These can be available when the user is in an on-grid mode (e.g. see FIG. 5 supra). Based on the content of the user's personal AR/VR broadcasts, other entities (e.g. businesses, social media contacts, etc.) can interact with various elements of the user's personal AR/VR broadcast. The user's personal AR/VR broadcast content can be generated dynamically and in real-time based on the attributes of the user and/or business viewing it. Personal AR/VR broadcasts can provide users the ability to recognize people. Personal AR/VR broadcasts can include access to a user's personal AR/VR chatbot that can vicariously communicate on behalf of the user. Personal AR/VR broadcasts can provide content that is an exemplification of user. For example, an AR/VR analytics engine can: study the user; match similarities with other users; make introductions; and provide similar interests via an AR/VR content and/or AR/VR chat session. User's can manually update the parameters of their own AR/VR chatbots. ML algorithms can be used to optimize the personal AR/VR chat bot personalities and interactions.

In step 804 manage business and other entity AR/VR broadcasts. An example business and other entity AR/VR broadcasts is provided in FIG. 9 as an AR/VR billboard. The business and other entity AR/VR broadcast content can be generated dynamically and in real-time based on the attributes of the user viewing it.

In step 806, process 800 can manage VR location-based views. In a VR-based aspect, process 800 can enable a user to determine a specified location and time frame. Process 800 can then amalgamate a set of AR/VR content and/or AR/VR broadcasts related to the location. The user can use a VR system to experience the content. The user does not need to be physically present at the location. In this way, the user can experience broadcasts using VR at specified time/place windows. The user can also access VR content and broadcasts in real-time. These can be superimposed on a location such that the user is enabled to view a virtual real-time view of broadcasts in a location, region, event, and the like.

FIG. 9 illustrates an example process 900 for implementing an AR/VR billboard, according to some embodiments. An AR/VR billboard is an example of a business or other entity AR/VR broadcast. Accordingly, process 900 can be modified to provide and manage other types of AR/VR broadcasts.

In step 902, process 900 can determine AR/VR billboard content. Example AR/VR content is provided in the screen shots provided herein. As discussed elsewhere, AR/VR content can include digital videos, images, sounds, etc. AR/VR content can be advertisements, entertainment, social media content, chatbot generated content, etc.

In step 904, process 900 can determine geo-fence of AR/VR billboard. In step 906, process 900 can detect that a user with an AR/VR device has entered the geo-fence. For example, a business can locate an AR/VR billboard on the front of a physical retail store. The AR/VR billboard can include digital AR/VR elements that are viewable by AR/VR systems of the users within a specified distance. This specified distance can form the geo-fenced region. The business can dynamically update the geo-fenced region based on various factors such as, inter alia: time of day, sales data, qualities of users, etc. For example, users who are returning customers can have a larger geo-fenced area applied than users merely commuting by the store.

In step 908, process 900 can determine that the user is in an on-grid mode. In step 910, process 900 can determine a region of gaze of the user. The region of gaze of the user can be the equivalent of the natural line of sight of the user. It can also be augmented such that the user can see the AR/VR content through physical objects (e.g. buildings, trees, etc.).

In step 912, process 900 can determine if the AR/VR billboard falls w/in a region of gaze of the user. For example, the user can be wearing AR goggles and viewing the location of the AR/VR billboard. The user can be holding a mobile device with the outward facing digital camera viewing the AR/VR billboard. If yes, then process 900 can proceed to step 914.

In step 914, process 900 can communicate AR/VR billboard content to the user's AR/VR system. For example, an AR/VR engine can operate the AR/VR billboard. The AR/VR engine can obtain a set of digital videos, images, sounds, etc., as well as, associated metadata. This information can be communicated to a client application operating in the user-side AR/VR system. The associated metadata can include hyperlinks, interfaces for interacting with an AR/VR chatbot, instructions for dynamic AR/VR display elements, etc.

In step 916, process 900 can display AR/VR billboard content in a user's AR/VR system. In step 918, process 900 can detect user interactions with AR/VR billboard content. These can include receiving user queries regarding the AR/VR billboard content, the company using the AR/VR billboard, etc. User queries can be voice queries, text queries, user gestures, etc.

In step 920, process 900 can, based on user interactions with AR/VR billboard content, implement a specified action. This can include providing the user incentives to purchase items. It can also include other actions such as: making reservations, chat bot sessions, scheduling appointments, ordering goods via an online marketplace, etc.

In step 922, process 900 can detect that a user with an AR/VR device has left the geo-fence and stop access of AR/VR content in a user's AR/VR system. The business can optionally communicate electronic messages (e.g. text messages, emails, etc.) to the user to continue communication with a user. The business can also store user behavior for later analytics.

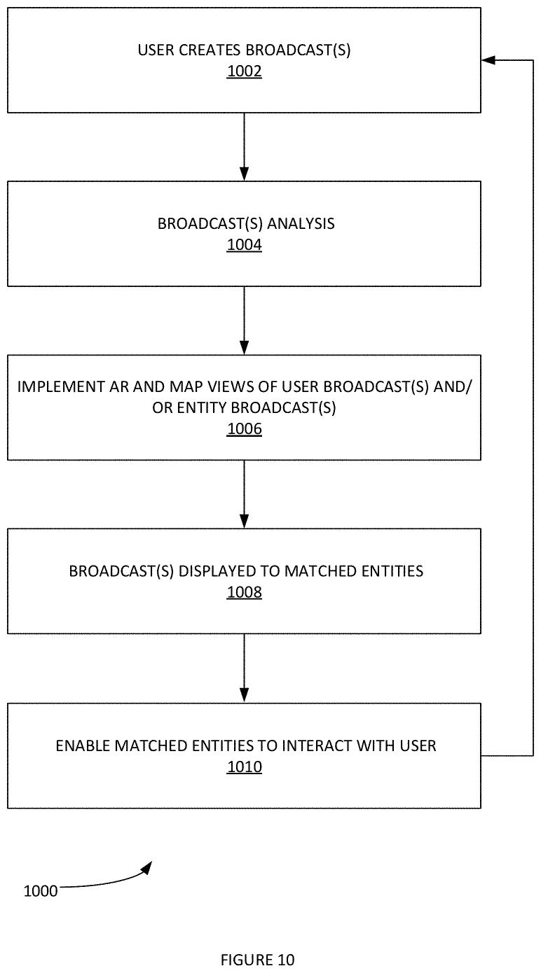

FIG. 10 illustrates an example process 1000 for implementing a broadcasts in an AR/VR platform, according to some embodiments. Process 1000 can connect a user's request and/or state with a real-time interaction with an entity capable of fulling the request. More specifically, in step 1002 process 1000 can enable a user to create broadcast(s). A broadcast be a user search that process 1000 can enable relevant entities to identify and respond to via a text messaging thread and/or an AR/VR session. Additionally, a user can create a broadcast state. A broadcast state can be a set of user preferences that the user enables process 1000 to broadcast.

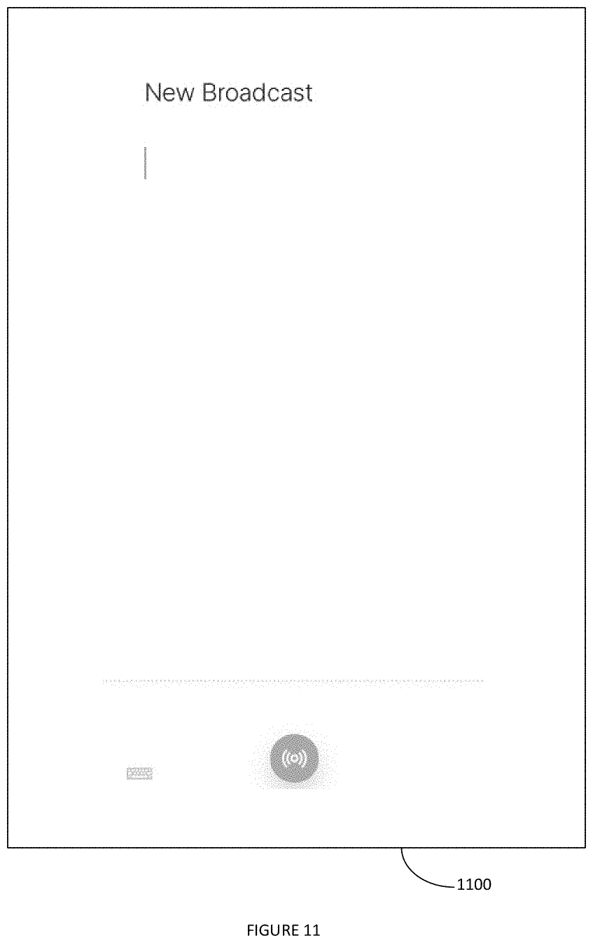

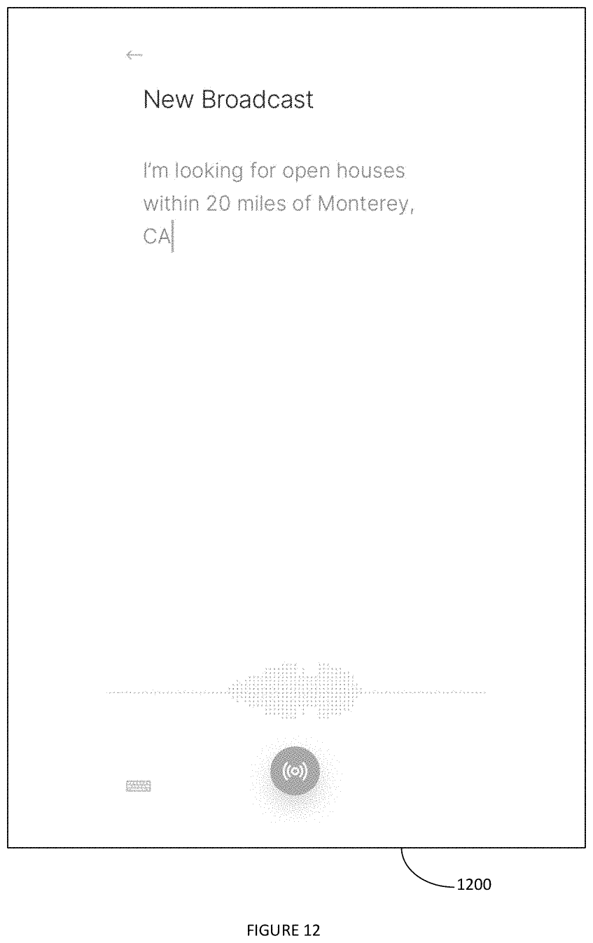

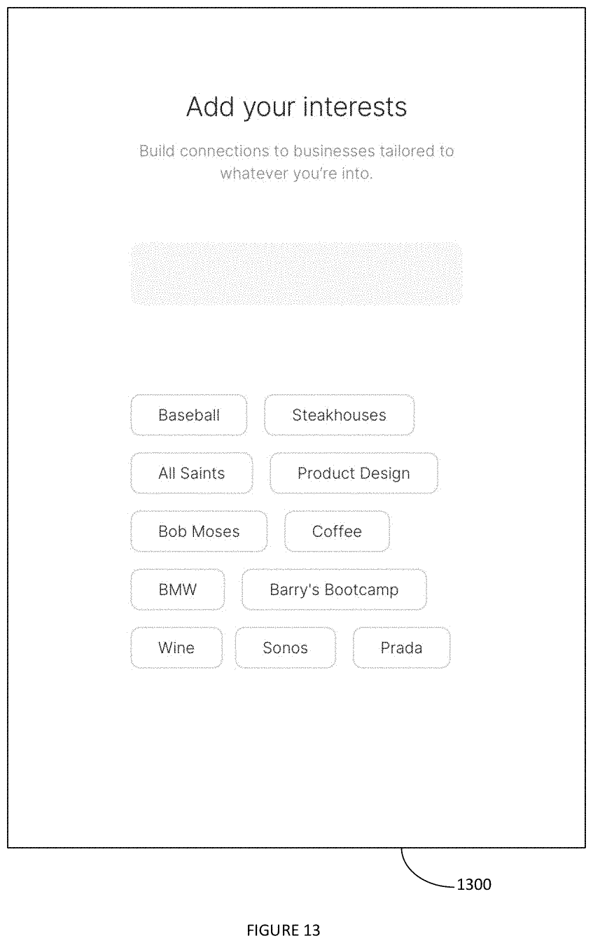

FIGS. 11-13 illustrates an example set of screenshots showing a user create a broadcast and a broadcast state. More specifically, FIGS. 11-12 illustrate two example user interface screenshots 1100 and 1200 for inputting a broadcast. A broadcast can be a text search that describes a service, product, other items, etc. that the user wishes to be connected with. The broadcast can include set of text and/or images. FIG. 13 illustrates an example user interface that enables a user to select/input various attributes. These attributes can be used to generate a broadcast state for the user. It is noted that user interfaces 1100-1300 can be implemented with an AR/VR platform mobile device application.

Returning to process 1000, these can be parsed and matched with various relevant service and product providers during analysis step 1004. In step 1004, process 1000 can use a key word mapping engine. The key word mapping engine can parse the incoming broadcast and identify key words. The key word mapping engine can then map the broadcasts with entities (e.g. businesses, educational institutions, person, non-profit organizations, governmental entities, etc.) that have bought rights to the key words. The broadcast state can be fed into the key word mapping engine as well. For example, the key word ‘coffee’ can be bought by a café within a specified radius. The key word ‘haircut’ can be bought by a salon in a town. The key word ‘steak’ can be bought by a restaurant in a county. The key word mapping engine can use various NLP, search engine, and/or ranking methods to implement the key word mapping. It is noted that broadcasts and responses to broadcasts can also be geo-tagged. In this way, the key word mapping engine can take into account the user's location, bearing, historical paths, etc. when matching a user's broadcast and/or broadcast state to an entity. This can be used to control an ‘air space’ such that the advertisements in the air space around an entity can be monetized (e.g. leased, purchased for specified key word search results, etc.).

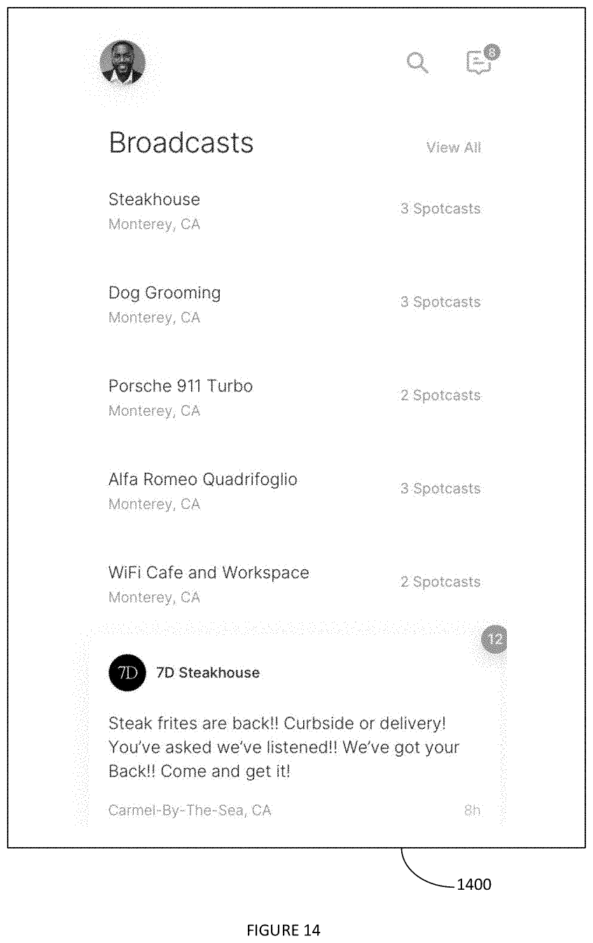

FIG. 14 illustrates a screenshot of a user interface 1400 of a series of broadcast interactions between a user and a set of businesses, according to some embodiments. As shown, the AR/VR platform mobile device application can organize and list the broadcast interactions. The list order can be based on various factors (e.g. recency, priority of broadcast, identity of entity, etc.). Historical messages between the user and the entities can also be accessible.

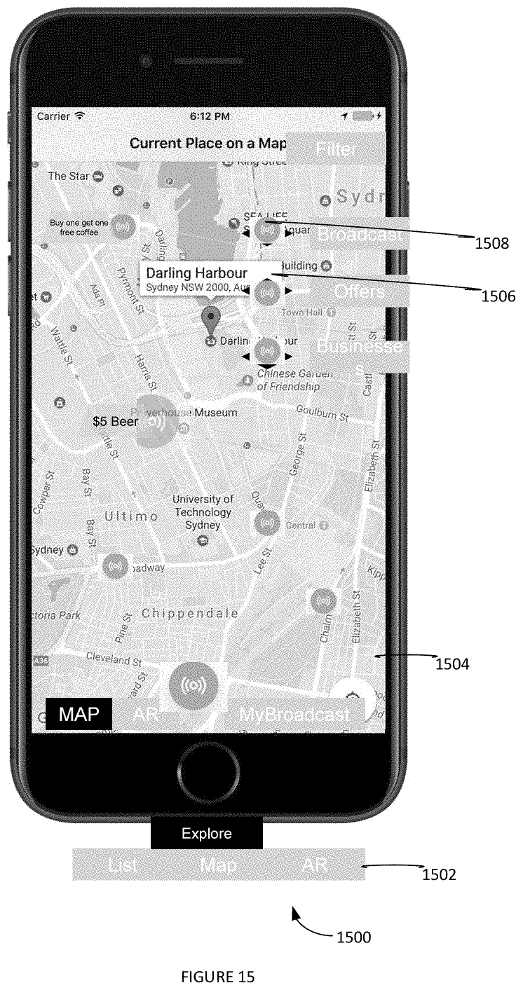

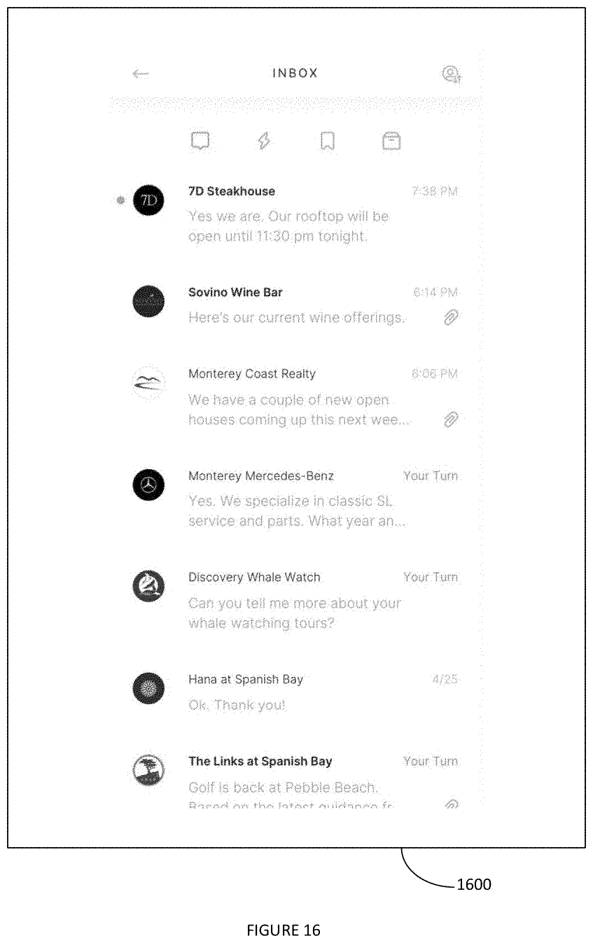

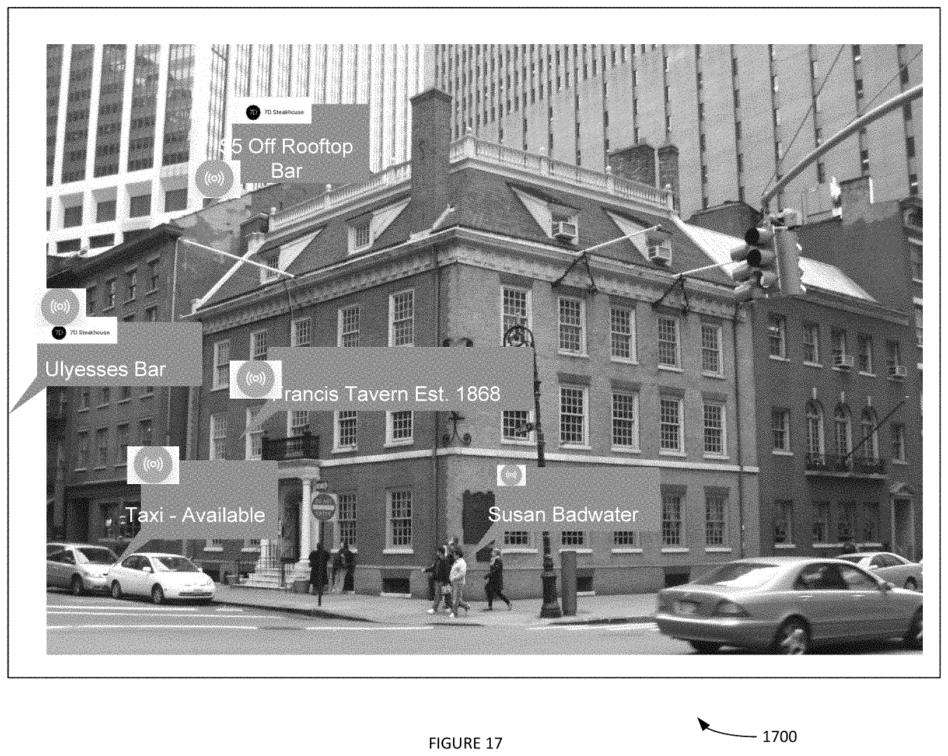

Returning to process 1000, in step 1006 implement AR/VR and map views of user broadcast(s) and/or entity broadcast(s). In step 1008, broadcast(s) displayed to matched entities 1008. In step 1010, process 1000 can enable matched entities to interact with user. For example, the AR markers and broadcast elements can include hyperlinks that link to an interface that provides a messaging option. These messaging can then be used to populate the list of FIG. 14 and FIG. 16. FIGS. 15 and 17 illustrate example implementations of steps 1006 and 1008.

FIG. 15 illustrates a map-based broadcast interface 1500, according to some embodiments. As shown, the AR/VR platform mobile device application can enable a user to toggle 1502 between the broadcast interaction interface 1400, the map-based broadcast interface 1500 and an AR/VR interface 1600 (see infra). The geo-location of the user and the geo-tags of entities can be used to generate the map-based broadcast interface 1500. User and entity broadcasts 1508 can be located on a web mapping service 1504. When a user clicks on an entity broadcast 1508 a more detailed view 1506 can be provided. This can include the entity name, address, digital images, etc. The view can include, inter alia: satellite imagery, aerial photography, street maps, 360° interactive panoramic views of streets, real-time traffic conditions, and route planning for traveling by foot, car, bicycle air and/or public transportation. Businesses can augment their broadcasts with short offers such as ‘buy one get one free’, ‘$5 beer’, etc. The user can also toggle between a filter mode, offers mode, business mode, etc.

FIG. 16 illustrates an example screenshot of a list of broadcast conversations with entities that match a user's broadcast specifications, according to some embodiments. The broadcast conversations with these entities can also be accessed by clicking on a particular item of the list. The user can be notified when it is the user's turn to respond to an entity. The broadcast conversations can time stamped. As a time-stamp decays, the list can be indexed to lower the ranking of the broadcast conversation.

FIG. 17 illustrates an example screenshot of a user interface 1700 for an AR view of a broadcast interface, according to some embodiments. Process 1000 can convert the geo-tagged broadcasts of the map of FIG. 15 and conversations of FIG. 16 to a set of geo-tagged AR markers. The user can view the geo-tagged AR markers via an AR/VR device and/or an AR application in a mobile device. The elements and presentation of the geo-tagged augmented reality markers can be modified based on various factors. For example, the farther away entity is, the smaller the geo-tagged AR marker is in the AR view. Entities can pay to have their geo-tagged AR markers enlarged and/or placed in more advantageous locations of the user's view.

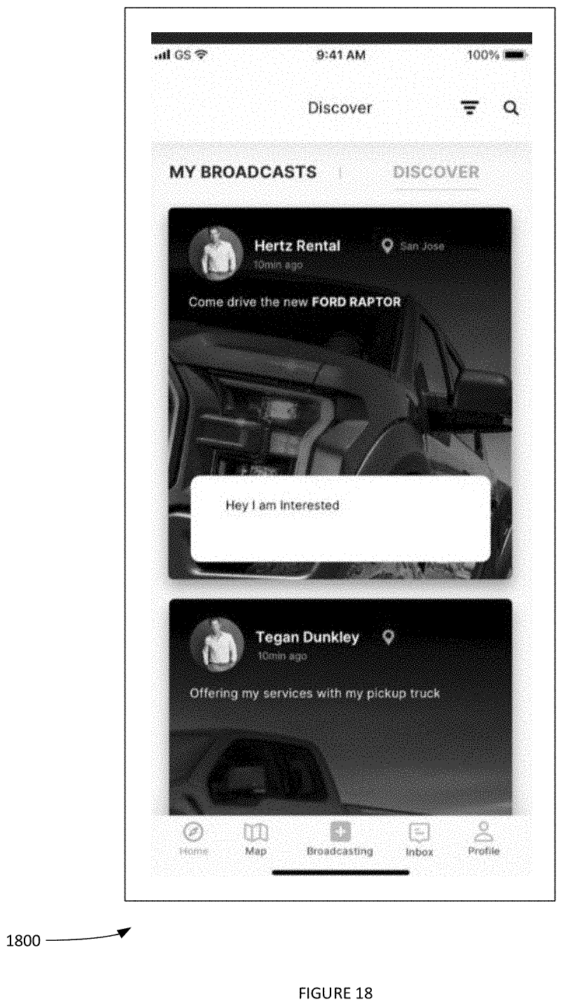

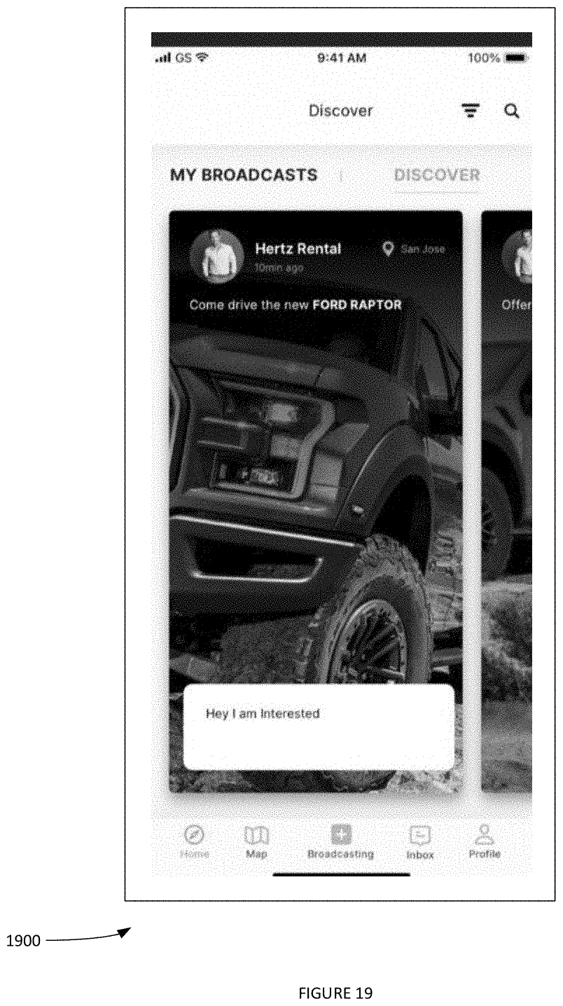

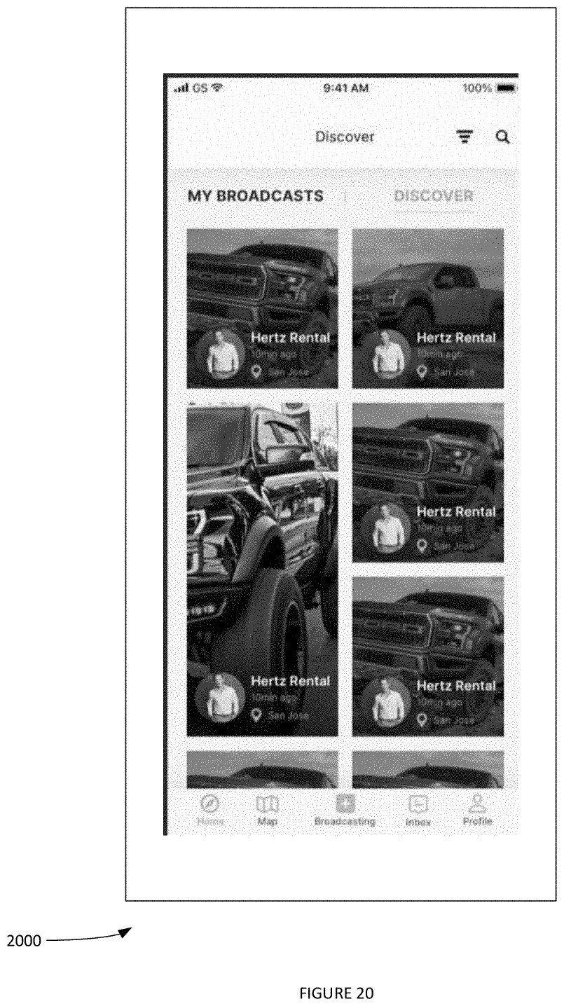

FIGS. 18-20 illustrate an additional set of example screenshots 1800-2000 regarding user broadcasts, according to some embodiments. It is noted that the AR/VR system can be able to analyze broadcast metadata for determining a self -preserved direction of the user. The AR/VR system can obtain broadcast metadata regarding, inter alia: how long a user views an object, what the user broadcasts, how long a user broadcasts specified information, how many other broadcasts does the user discover around them, etc. The AR/VR system can use this metadata to develop a better experience of what the user would be interested in looking at. The AR/VR system can then use various ML and prediction methods using this broadcast metadata to predict a set of other broadcasts the user may be interested in reviewing. The prediction set of broadcasts can then be pushed to the user's AR/VR experience. Broadcasts can be clicked on to enable chat functionality between the two users. User can select to be on-grid/off-grid as noted supra.

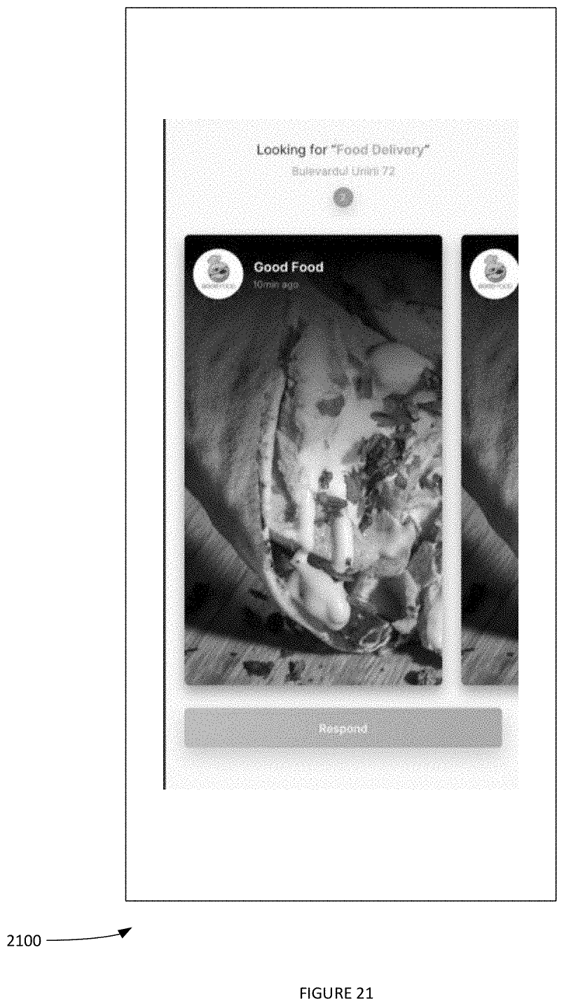

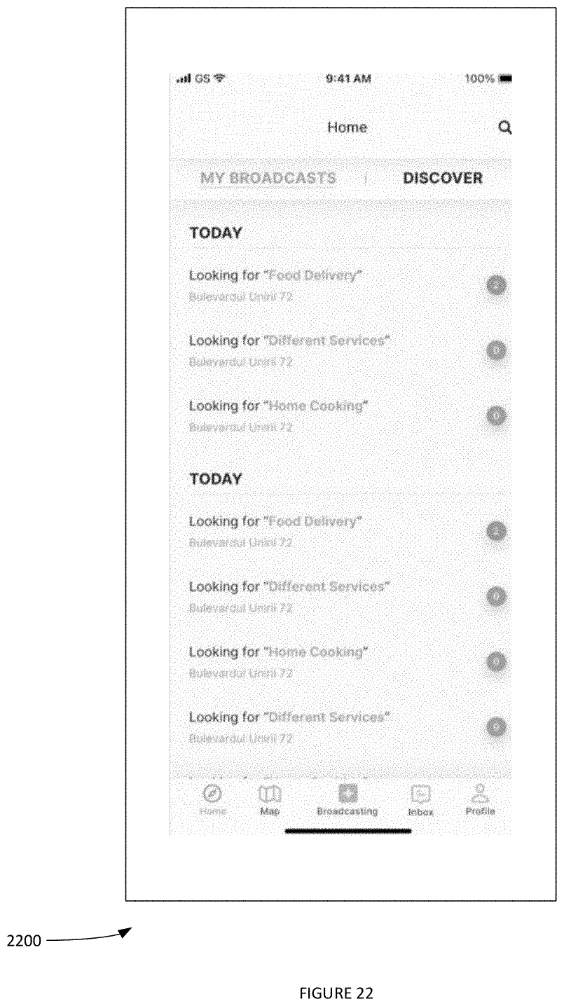

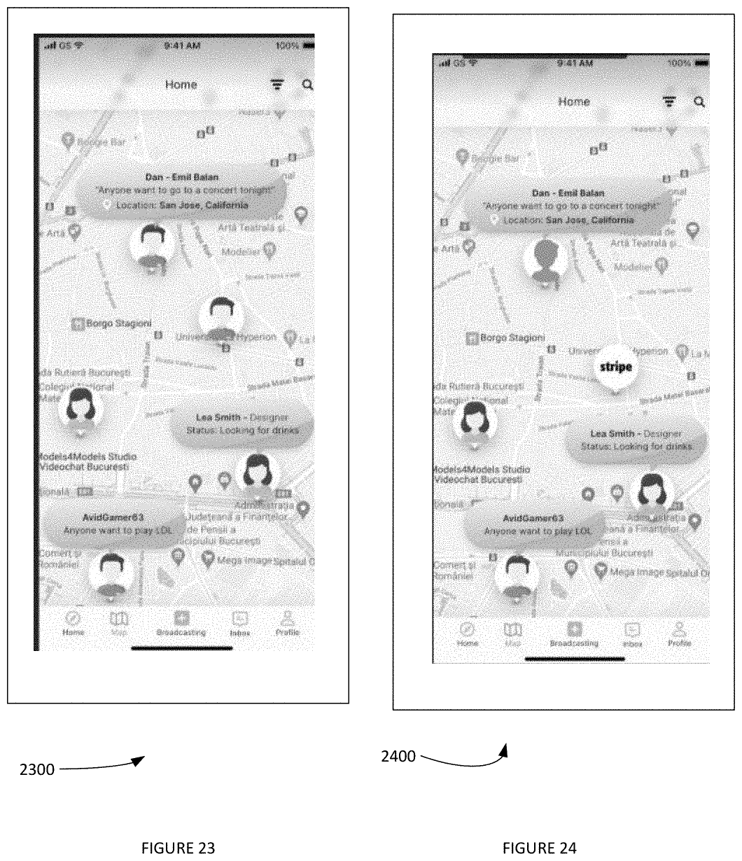

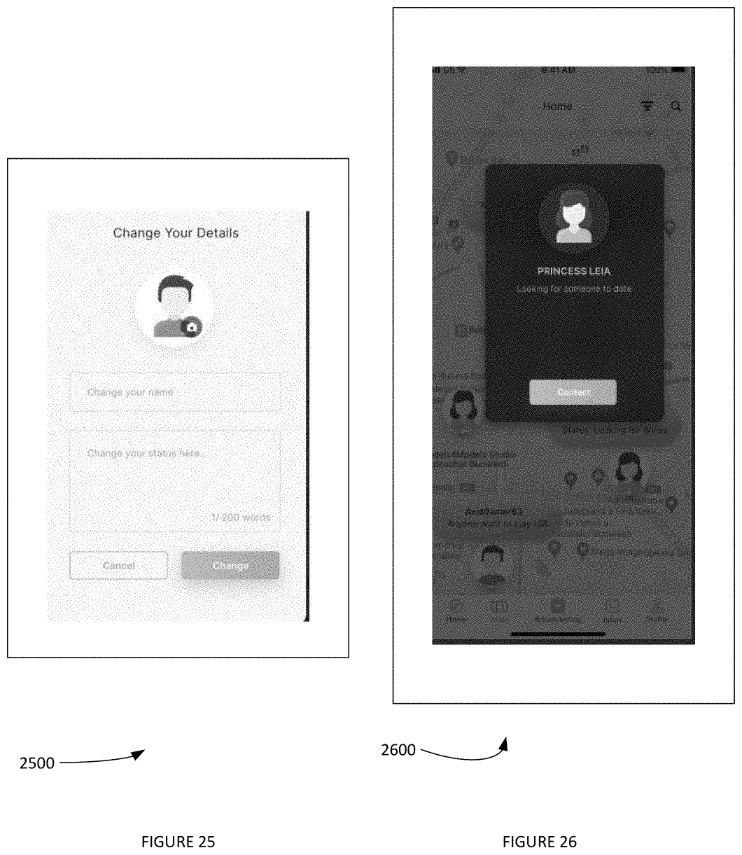

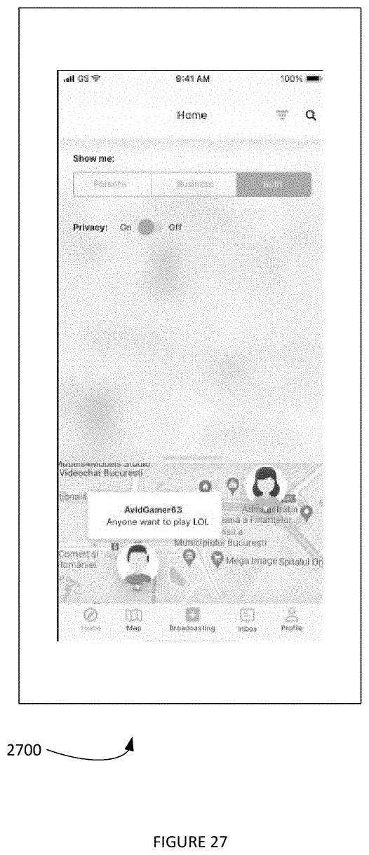

FIGS. 21-22 illustrate an example set of screenshots 2100-2200 related to a discovery option/service, according to some embodiments. Discovery can be an extension of the services provided in FIG. 14 supra. The discovery tab can enable a user to see what other users are broadcasting about. FIGS. 23-27 illustrate a set of map-based interfaces 2300-2700 for discovering and interacting with other users via their respective broadcasts, according to some embodiments. As shown, the interactions can be via an in-application messaging interface that is activated once a user (or both users) click on the broadcast.

It is noted that the content of the present screen shot examples are presently available in AR/VR. This is embodied in any broadcast to be implemented automatically by AR/VR chat bot(s) 114. Furthermore, machine-learning engine 116 can optimize the content of the AR/VR experience for each individual user.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method for implementing an augmented reality (AR)/virtual reality (VR) session comprising:
providing an AR/VR engine communicatively coupled with a user AR/VR device, wherein the AR/VR engine obtains a set of digital content and communicates the set of digital content to the user-side AR/VR device;
determining that a user initiates a broadcast for a service or product;
with the AR/VR engine, notifying the user via the user AR/VR device of a relevant service or product provider of broadcast by sending a push notification to the relevant service or product provider; and
enabling an interaction between the user and the relevant service or product provider.

2. terminates the AR/VR session when the user and relevant service or product provider(s) have completed their interaction(s

3. The method of claim 1, wherein the AR/VR engine operates an AR/VR billboard.

4. The method of claim 3, wherein the set of digital content comprises a set of associated metadata that comprises one or more hyperlinks, interfaces for interacting with an AR/VR chatbot, and a set of instructions for dynamic AR/VR display elements.

5. The method of claim 1, wherein the relevant service or product provide and user interactions are implemented during an AR/VR session.

6. The method of claim 5, wherein the user makes a reservation at a restaurant, purchase a product, of schedules a service during the AR/VR session.

7. The method of claim 1, wherein the broadcast comprises a set of visual status icons, avatars, sponsored or purchased labels, and audio elements.

8. The method of claim 7, wherein a visual status icons is dynamically updated based on a user-related context.

9. The method of claim 8, wherein the user is enabled to adjust a filter on which AR/VR displays/broadcasts are visible via the user-side AR/VR device.

10. A computerized method for implementing an augmented reality (AR)/virtual reality (VR) billboard comprising:
determining the AR/VR billboard content;
setting a geo-fence of the AR/VR billboard;
detecting that a user with an AR/VR device has entered the geo-fence, wherein the AR/VR billboard comprises a set of digital AR/VR elements that are viewable by the user AR/VR device while the user is within the geo-fence;
determining that the user is in an on-grid mode;
determining a region of gaze of the user;
communicating the AR/VR billboard content to the AR/VR device of the user;
displaying the AR/VR billboard content in the AR/VR device of the user;
detecting a user interaction with the AR/VR billboard content; and
based on the user interaction with the AR/VR billboard content, implementing a specified action.

11. The computerized method of claim 10, wherein the AR/VR content comprises a digital advertisement, a digital entertainment, a digital social media content, or a chatbot generated content.

12. The computerized method of claim 10, wherein a business locate the AR/VR billboard at a front of a physical retail store.

13. The computerized method of claim 12, wherein the business dynamically updates a size of the geo-fenced area based on a time of day, and an attribute of the user.

14. The computerized method of claim 13, wherein the user is detected to be a returning customer, and wherein the geo-fence is automatically increase to a greater size than when it is detected that the user commuting by the business.

15. The computerized method of claim 14, wherein the user interaction with the AR/VR billboard content comprises a voice query, a text query, and a user gestures as detected by the AR/VR device of the user.

16. The computerized method of claim 15, wherein the specified action comprises providing the user incentives to purchase an item, making a reservation, implementing a chat bot session, and scheduling an appointment.

17. The computerized method of claim 16 further comprising:
detecting that the user with the AR/VR device has left the geo-fence.

18. The computerized method of claim 17 further comprising:
stopping access to the AR/VR content of the AR/VR billboard in the AR/VR device of the user.

19. The computerized method of claim 18, wherein the on-grid mode enables the user to search for a broadcasts and be visible in the broadcast searches of another entity in the AR/VR system.
